(19) United States
(12) Patent Application Publication
(10) Pub. No.: US 2022/0405527 A1
(43) Pub. Date: Dec. 22, 2022

(54) Target Detection Methods, Apparatuses, Electronic Devices and Computer-Readable Storage Media

(71) Applicant: SENSETIME INTERNATIONAL PTE. LTD., Singapore (SG)

(72) Inventors: Jinghuan Chen, Singapore (SG); Chunya Liu, Singapore (SG); Xuesen Zhang, Singapore (SG); Bairun Wang, Singapore (SG)

(21) Appl. No.: 17/364,059

(22) Filed: Jun. 30, 2021

Related U.S. Application Data
(63) Continuation of application No. PCT/IB2021/055671, filed on Jun. 25, 2021.

(30) Foreign Application Priority Data
Jun. 17, 2021 (SG) 10202106559T

(51) Int. Cl. G06K 9/62; G06T 7/70; G06T 7/11; G06K 9/46

(52) U.S. Cl. CPC G06K 9/627; G06T 7/70; G06T 7/11; G06K 9/46; G06K 9/6256; G06T 2207/20132; G06T 2207/20081

(57) ABSTRACT

A target detection method and apparatus, an electronic device and a computer-readable storage medium are provided by the embodiments of the present disclosure. The method includes: obtaining a detection result by performing a target detection on a to-be-detected image, wherein the detection result comprises a target classification to which a target object involved in the to-be-detected image belongs and position information corresponding to the target object involved in the to-be-detected image; cropping out a proposal image involving the target object from the to-be-detected image based on the position information; determining a confidence that the target object belongs to a target classification based on the proposal image; and deleting, in response to that the confidence is less than a preset threshold, an information item concerned the target object from the detection result.

### CROSS REFERENCE TO RELATED APPLICATION

This application is a continuation application of International Application No. PCT/IB2021/055671 filed on Jun. 25, 2021, which claims priority to Singapore Patent Application No. 10202106559T, filed on Jun. 17, 2021, entitled “TARGET DETECTION METHODS, APPARATUSES, ELECTRONIC DEVICES AND COMPUTER-READABLE STORAGE MEDIA,” the disclosure of which is incorporated herein by reference in its entirety for all purposes.

### TECHNICAL FIELD

The present disclosure relates to deep learning technology, in particular to a target detection method, an apparatus, an electronic device and a computer-readable storage medium.

### BACKGROUND

Target detection is an important part of intelligent video analysis system. When performing the target detection, the detection on a target object in a scene (such as a specific object) is desired to have high accuracy, while objects other than the target object can be referred to as foreign things. In general, using a common method of detecting a target object is difficult to obtain an accurate detection result for a foreign thing, which makes the foreign thing easy to be detected as the target object. However, during the target detection, it is not desired that the foreign thing is falsely detected, thereby affecting the analysis of a system.

### SUMMARY

In view of this, the present disclosure provides a target detection method, an apparatus, an electronic device and a storage medium.

In a first aspect, a target detection method is provided, including: obtaining a detection result by performing a target detection on a to-be-detected image, wherein the detection result includes a target classification to which a target object involved in the to-be-detected image belongs and position information corresponding to the target object involved in the to-be-detected image; cropping out a proposal image involving the target object from the to-be-detected image based on the position information; determining a confidence that the target object belongs to a target classification based on the proposal image; deleting, in response to that the confidence is less than a preset threshold, an information item concerned the target object from the detection result.

With reference to any of the embodiments of the present disclosure, obtaining the detection result by performing the target detection on the to-be-detected image includes: obtaining the detection result by performing the target detection on the to-be-detected image with the target detection network; wherein the target detection network is trained to detect respective target object of each of a plurality of classifications.

With reference to any of the embodiments of the present disclosure, determining the confidence that the target object belongs to the target classification based on the proposal image includes: determining the confidence that the target object belongs to the target classification based on an image feature extracted by performing a feature extraction on the proposal image with a filter; wherein the filter is trained to detect a target object of the target classification.

With reference to any of the embodiments of the present disclosure, the filter is trained by operation including: extracting an image feature by performing the feature extraction on a sample image with the filter; determining, based on the extracted image feature, a confidence that the sample image belongs to a labeled classification of the sample image, the sample image includes: a positive sample image involving a target object of the target classification and a negative sample image involving an interfering object which does not belong to the target classification; determining a network loss based on the confidence and the labeled classification of the sample image; adjusting a network parameter of the filter based on the network loss.

With reference to any of the embodiments of the present disclosure, the sample image includes at least two classifications of positive sample images, and each of the at least two classifications of positive sample images corresponds to a preset display status of the target object.

With reference to any of the embodiments of the present disclosure, the target object includes a chip-like object which has a marking side and another side opposite to the marking side; the at least two classifications of positive sample images include: an image involving the chip-like object with a first display status in which the marking side of the chip-like object is visible, or an image involving the chip-like object with a second display status in which the marking side of the chip-like object is invisible.

With reference to any of the embodiments of the present disclosure, the method further includes: taking, in response to that the confidence is less than the preset threshold, the proposal image as a negative sample image to train the filter.

With reference to any of the embodiments of the present disclosure, in a case that one or more target objects are detected from the to-be-detected image, for each of the one or more target objects, the detection result includes: a target classification to which the target object belongs and position information corresponding to the target object involved in the to-be-detected image; determining the confidence that the target object belongs to the target classification based on the proposal image includes: determining, with a filter corresponding to the target classification to which the target object belongs, the confidence that the target object belongs to the target classification based on the proposal image involving the target object.

With reference to any of the embodiments of the present disclosure, the to-be-detected image includes an image of a game table, and the one or more target objects include at least one of: a game prop, a game prop operating part, and a game coin.

With reference to any of the embodiments of the present disclosure, the method further includes: storing, in response to that the confidence is greater than or equal to the preset threshold, the detection result.

In a second aspect, a target detection apparatus is provided, including: a target detection module, configured to obtain a detection result by performing a target detection on a to-be-detected image, wherein the detection result includes a target classification to which a target object involved in the to-be-detected image belongs and position information corresponding to the target object involved in the to-be-detected image; an image cropping module, configured to crop out a proposal image involving the target object from the to-be-detected image based on the position information; a confidence determining module, configured to determine a confidence that the target object belongs to a target classification based on the proposal image; a result determining module, configured to delete, in response to that the confidence is less than a preset threshold, an information item concerned the target object from the detection result.

With reference to any of the embodiments of the present disclosure, the target detection module is configured to obtain the detection result by performing the target detection on the to-be-detected image with the target detection network; wherein the target detection network is trained to detect respective target objects of each of a plurality of classifications.

With reference to any of the embodiments of the present disclosure, the confidence determining module is configured to determine the confidence that the target object belongs to the target classification based on an image a feature extracted by performing feature extraction on the proposal image with a filter; wherein the filter is trained to detect a target object of the target classification.

With reference to any of the embodiments of the present disclosure, the filter is trained by operations including: extracting an image feature by performing the feature extraction on a sample image with the filter; determining, based on the extracted image feature, a confidence that the sample image belongs to a labeled classification of the sample image, the sample image includes: a positive sample image involving a target object of the target classification and a negative sample image involving an interfering object which does not belong to the target classification; determining a network loss based on the confidence and the labeled classification of the sample image; adjusting a network parameter of the filter based on the network loss.

With reference to any of the embodiments of the present disclosure, the sample image includes at least two classifications of positive sample images, and each of the at least two classifications of positive sample images corresponds to a preset display status of the target object.

With reference to any of the embodiments of the present disclosure, the target object includes a chip-like object which has a marking side and another side opposite to the marking side; the at least two classifications of positive sample images include: an image involving the chip-like object with a first display status in which the marking side of the chip-like object is visible, or an image involving the chip-like object with a second display status in which the marking side of the chip-like object is invisible

With reference to any of the embodiments of the present disclosure, the result determining module is configured to: take, in response to that the confidence is less than the preset threshold, the proposal image as a negative sample image to train the filter.

With reference to any of the embodiments of the present disclosure, in a case that one or more target objects are detected from the to-be-detected image, for each of the one or more target objects, the detection result includes: a target classification to which the target object belongs and position information corresponding to the target object involved in the to-be-detected image; the confidence determining module is configured to: determine, with a filter corresponding to the target classification to which the target object belongs, the confidence that the target object belongs to the target classification based on the proposal image involving the target object.

With reference to any of the embodiments of the present disclosure, the to-be-detected image includes an image of a game table, and the one or more target objects include at least one of: a game prop, a game prop operating part, and a game coin.

With reference to any of the embodiments of the present disclosure, the result determining module is further configured to: store, in response to that the confidence is greater than or equal to the preset threshold, the detection result.

In a third aspect, an electronic device is provided, including a memory and a processor, wherein the memory is configured to store computer-readable instructions that can be run on the processor and when the instructions are executed by the processor, the target detection method described in any of the embodiments of the present disclosure is implemented.

In a fourth aspect, a computer-readable storage medium is provided, having a computer program stored thereon, where when the computer program is executed by a processor, the target detection method described in any of the embodiments of the present disclosure is implemented.

In a fifth aspect, a computer program product including computer program(s)/instructions is provided, where when the computer program(s)/instructions are run in a processor, the target detection method described in any of the embodiments of the present disclosure is implemented.

In the embodiments of the present disclosure, based on target detection, a confidence that a target object, determined by the target detection, belongs to a target classification is determined through a proposal image corresponding to the target object, and based on the confidence, it is effectively determined that whether the target object belongs to the target classification of the target object to be detected and a target object of which the confidence is less than a preset threshold is filtered out, thereby reducing false detections and improving the accuracy of the detection without increasing data load.

### BRIEF DESCRIPTION OF THE DRAWINGS

To explain the technical solutions in one or more embodiments of the present disclosure or in related art more clearly, the drawings used in the description of the embodiments or related art will be briefly introduced below. Apparently, the drawings in the following description are only one or more embodiments of the present disclosure. For those of ordinary skill in the art, other embodiments can be obtained based on these drawings without paying creative labor.

FIG. 1 is a flowchart of a target detection method shown in some embodiments of the present disclosure.

FIG. 2 is a schematic diagram illustrating a structure of a target detection network and a filter shown in some embodiments of the present disclosure.

FIG. 3 is flowchart of a training method for a filter shown in some embodiments of the present disclosure.

FIG. 4 is a flowchart of another target detection method shown in some embodiments of the present disclosure.

FIG. 5 is a flowchart of another target detection method shown in some embodiments of the present disclosure.

FIG. 6 is a flowchart of a target detection method in a scenario of a game venue shown in some embodiments of the present disclosure.

FIG. 7 is a block diagram illustrating a target detection apparatus shown in some embodiments of the present disclosure.

FIG. 8 is a block diagram an electronic device shown in some embodiments of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in this specification are only for the purpose of describing specific embodiments, and are not intended to limit the disclosure. The singular forms of “a”, “said” and “the” used in this disclosure and appended claims are also intended to include plural forms, unless the context clearly indicates other meanings. It should also be understood that the term “and/or” as used herein refers to and includes any or all possible combinations of one or more associated listed items.

It should be understood that although the terms first, second, third, etc. may be used in this disclosure to describe various information, the information should not be limited to these terms. These terms are only used to distinguish the same type of information from each other. For example, without departing from the scope of this specification, first information may also be referred to as second information, and similarly, the second information may also be referred to as the first information. Depending on the context, the word “if” as used herein can be interpreted as “when” or “while” or “in response to determining that”.

As shown in FIG. 1, FIG. 1 is a flowchart of a target detection method shown in some embodiments of the present disclosure. The method may include the following steps:

At step 100, a detection result is obtained by performing a target detection on a to-be-detected image.

The detection result includes a target classification to which a target object involved in the to-be-detected image belongs and position information corresponding to the target object involved in the to-be-detected image.

In this step, the to-be-detected image may include target objects of different classifications, and may also include other objects. The target object is the detecting target during the target detection. In different scenarios, the target objects detected in target detection are different. For example, in a road scene, the target objects can be vehicles and pedestrians, and other objects can be trees, pets, and buildings. For another example, in a scene of face recognition, the target objects can be human faces, and the other objects can be cartoon faces. There may be one or more target objects involved in the to-be-detected image, or there may be other objects, or there may be no other object.

A false detection may occur during the target detection. When the target detection is performed on the to-be-detected image, another object may be falsely detected as the target object of a certain target classification.

After the target detection is performed on the to-be-detected image, a detection result can be obtained. The detection result can include a target classification to which each target object involved in the to-be-detected image belongs and the position information corresponding to each target object involved in the to-be-detected image. The position information can be the frame coordinate information of the frame where the target object is located. Specifically, it can be the coordinate information corresponding to four vertices of a rectangular frame that just frames the target object involved in the to-be-detected image, or it can be a fixed-size rectangular frame surrounding the target object. For the coordinate information corresponding to the four vertices, this embodiment does not limit the specific representation of the position information.

This embodiment does not limit the specific method of target detection. For example, the target detection may be performed by a trained neural network, or the target detection may also be performed in other ways.

At step 102, based on the position information, a proposal image involving the target object is cropped out from the to-be-detected image.

In this step, the image of a region where each target object is located can be cropped out from the to-be-detected image according to the position information corresponding to the target object. The image of this region is the proposal image. One or more proposal images can be obtained from the to-be-detected image.

For example, when the position information is the frame coordinate information corresponding to the frame where the target object is located, the frame where each target object is located can be cropped out from the to-be-detected image to obtain a proposal image.

The proposal image may involve a real target object, or it may involve another object that have been falsely detected as the target object.

At step 104, a confidence that the target object belongs to the target classification is determined according to the proposal image.

This embodiment does not limit the specific manner of determining the confidence. For example, the trained neural network may be used to perform a feature extraction and determine the confidence, or the confidence may also be determined in other ways.

For example, feature extraction can be performed on each proposal image to obtain an image feature of the proposal image. The confidence that the corresponding target object belongs to the target classification can be predicted according to the image feature. The higher the confidence, the greater the probability that the target object belongs to the target classification.

Alternatively, confidence that the corresponding target object does not belong to the target classification can also be predicted. The lower the confidence, the greater the probability that the target object does not belong to the target classification.

For example, when it is determined during the target detection that the target classification to which the target object belongs is vehicle, a confidence that the target object belongs to the classification of vehicle can be determined according to the image feature extracted from the proposal image corresponding to the target object, or a confidence that the target object does not belong to the object classification of vehicle can be determined.

At step 106, in response to that the confidence is less than a preset threshold, an information item concerned the target object is deleted from the detection result.

In this step, after the confidence that the target object belongs to the target classification is determined, if the confidence is less than the preset threshold, it is determined that the target object is falsely detected as an object of the target classification. Then an information item concerned the target object is deleted from the detection result. If the confidence is greater than or equal to the preset threshold, it is determined that the target object is an object of the target classification. In an example, in response to that the confidence is greater than or equal to the preset threshold, the detection result may be stored.

In another example, after determining the confidence that the target object does not belong to the target classification, if the confidence is greater than or equal to a preset threshold, it is determined that the target object is another object that has been falsely detected as the target object, and an information item concerned the target object is deleted from the detection result. If the confidence is less than the preset threshold, it is determined that the target object is an object of the target classification. The specific preset threshold can be set by those skilled in the art according to actual needs.

The target detection method provided by the embodiments of the present disclosure determines the confidence that the target object belongs to a target classification based on a detection result of the target detection and a proposal image corresponding to the detected target object, and effectively verifies the classification detection result through the confidence of the target object, filters out the target objects with a confidence less than a preset threshold in the detection result. As a result, foreign things that are not easily distinguished by the target detection on the to-be-detected image can be filtered out without increasing the data load, thereby reducing false detections and improving the accuracy of the detection.

In one embodiment, performing target detection on the to-be-detected image to obtain the detection result includes: performing the target detection on to-be-detected image by a target detection network to obtain the detection result. The target detection network is trained to detect respective target objects of each of a plurality of classifications. By inputting the to-be-detected image into the target detection network, the classification to which the target object involved in to-be-detected image belongs can be obtained as the target classification, and the position information corresponding to the target object involved in the to-be-detected image can be obtained. The target detection network may be a neural network trained by using an image involving at least one classification of target object as a sample. Using the target detection network can more accurately and quickly identify the target object of the target classification in the to-be-detected image. In addition, since in general, the number of the classifications of the target object involved in the training samples of the target detection network is limited, by using a filter to further filter the target objects of the target classification detected by the target detection network, false detections caused by the lack of data on foreign things in the training samples for the target detection network can be reduced.

In an embodiment, determining the confidence that the target object belongs to the target classification based on the proposal image includes: determining a confidence that the target object belongs to the target classification based on an image feature extracted by performing a feature extraction on the proposal image with a filter, where the filter is trained to detect a target object of the target classification. The filter can be a trained binary classification neural network. By inputting the proposal image into the filter, or inputting the feature extracted from the proposal image into the filter, the confidence that the target object belongs to the target classification can be obtained. Using filters can get the confidence that the target object belongs to the target classification more accurately and quickly.

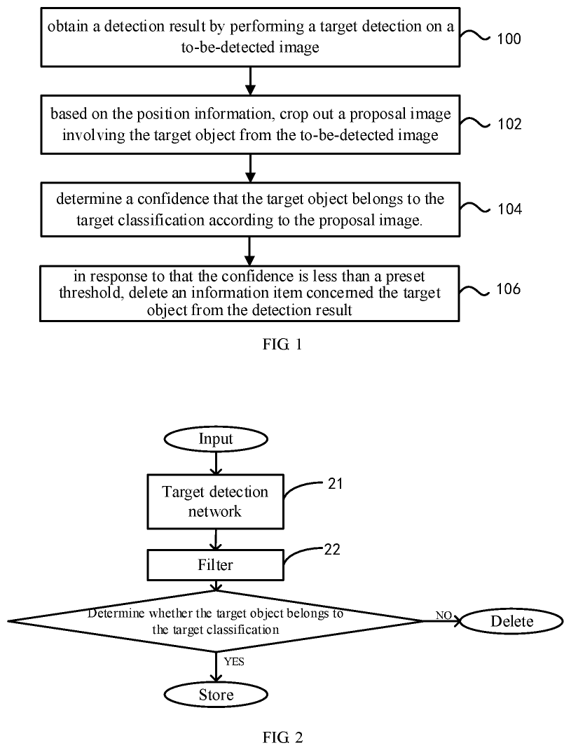

The target detection method provided by an embodiment of the present disclosure can be performed through a target detection network and a filter. FIG. 2 illustrates the structure of the target detection network 21 and the filter 22 used in the target detection method.

The target detection network 21 is configured to perform target detection on the input to-be-detected image to obtain a detection result, where the detection result includes the target classification to which the target object involved in the to-be-detected image belongs and the position information corresponding to the target object involved in the to-be-detected image.

According to the position information output by the target detection network 21, a proposal image involving the target object can be cropped out from the to-be-detected image.

The filter 22 is configured to determine the confidence that the target object belongs to a certain target classification according to the image feature obtained by performing feature extraction on the proposal image. In actual implementation, the proposal image may be input to the filter 22, and the image feature obtained by performing the feature extraction on the proposal image by the filter 22 may also be obtained by the feature extraction of the proposal image in other ways, such as using a neural network for feature extraction. As a result, the extracted image feature is input to the filter 22.

According to the confidence output by the filter 22, it can be determined whether the target object belongs to the target classification and an information item concerned the target object is deleted from or stored in the detection result.

The target detection network used in the embodiments of the present disclosure can be the detection network model commonly used in target detection, and trained according to the commonly used methods. Example of the detection network includes as Faster RCNN (Faster region-based convolutional neural network), Fast RCNN (Fast region-based convolutional neural network), and R-CNN (Region-based convolutional neural network), etc. This embodiment does not limit the specific neural network and training method used by the target detection network.

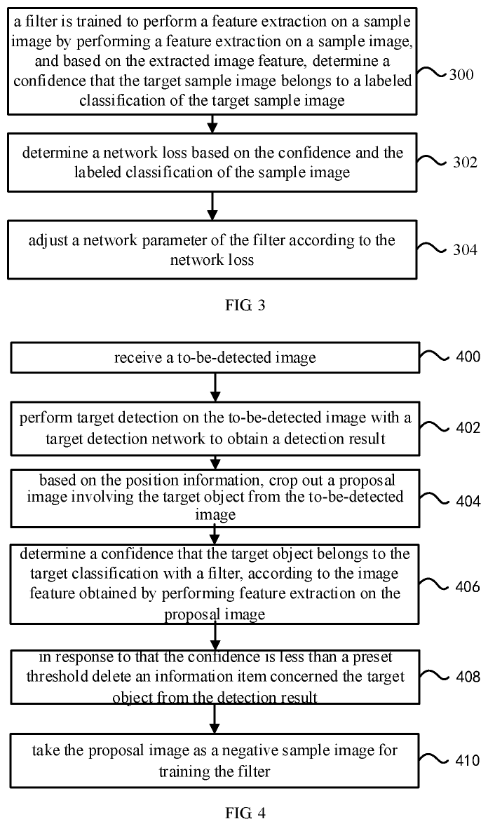

FIG. 3 shows a training process of a filter used in the target detection method provided by an embodiment of the present disclosure, that is, a method for training the filter shown in FIG. 2, and the filter is configured to filter out a certain classification of target object, including the following steps:

At step 300, a filter is trained to extract an image feature by performing a feature extraction on a sample image, and based on the extracted image feature, a confidence that the target sample image belongs to a labeled classification of the target sample image is determined.

The filter used in this embodiment may be a classifier based on deep learning, for example, a residual neural network (resnet), a deep convolutional neural network (VGGNet), a dense convolutional network (DenseNet) and other deep learning models.

A binary classification task is constructed for the filter, where each filter is used to filter out target objects of a target classification, and a large number of sample images corresponding to the target classification are used to complete the training. The sample image includes a positive sample image involving a target object of the target classification and a negative sample image involving an interfering object. A labeled classification of the positive sample image can be 1, and the labeled classification of the negative sample image can be 0. Alternatively, the labeled classification of the positive sample image can be 0, and the labeled classification of the negative sample image can be 1. In order to improve the training performance, the number of positive sample images and negative sample images can also be kept the same.

The interfering object is another object that do not belong to the target classification. In particular, the interfering object may be another object similar to the target object. For example, in the case where the target object is a bus, the interfering object may be a private car. For another example, when the target object is a water cup, the interfering object may be a vase, a pen holder, etc. The sample image generally includes only one target object or interfering object.

In an example, the sample image includes at least two classifications of positive sample images, and each of the at least two classifications of positive sample images corresponds to a preset display status of the target object. The positive sample image used in this example includes different display status of the target object, so that the trained filter is more robust and can more accurately filters the target object of the target classification.

For example, in the case where the target object is a block-like object, the block-like object has a front side, a rear side, and a top side. The sample image can include three classifications of the positive sample. The target object of the target classification can have three classification of preset display statuses for the three classifications of the positive sample image respectively, which are: the front of the block-like object is visible, the rear side of the block-like object is visible, and the top side of the block-like object is visible. For example, for a vehicle, the front side is where the window shield is located, the rear side is where the door is located, and the top side is where the roof is located.

For example, in the case where the target object is a chip-like object which has a marking side and another side opposite to the marking side, the display statuses are marking side visible and marking side invisible. The at least two classifications of positive sample images include: an image involving the chip-like object with a first display status in which the marking side of the chip-like object is visible, or an image involving the chip-like object with a second display status in which the marking side of the chip-like object is invisible. The positive sample image used in this example includes not only the display status where the marking side of the chip-like object is visible, but also the display status where the marking side of the chip-like object is invisible, so that the filter can obtain accurate detection result of the chip-like object in different status.

By inputting the sample image into the filter and performing feature extraction on the sample image by the filter, a confidence that the sample image belongs to the labeled classification of the sample image can be determined based on the extracted image feature.

For example, feature extraction can be performed on the sample image by a convolution layer in the filter, and extracted image features can be integrated by a fully connected layer in the filter. The confidence that the sample image belongs to the labeled classification of the sample image is output after performed a regression process by a Softmax layer.

At step 302, a network loss is determined based on the confidence and the labeled classification of the sample image.

In this step, based on the confidence and the labeled classification of the sample image, the network loss can be calculated through a loss function. The loss function is used to determine a difference between an actual output and an expected output, that is, the difference between the confidence output by the filter and the labeled classification of the sample image. This embodiment does not limit the specific loss function used. For example, a quantile loss function, a mean square error loss function or a cross entropy loss function can be used.

In an example, a binary cross entropy loss function can be used to train the filter:

L(x,y)=y*log(x)+(1−y)*log(1−x) (1)

where x is the confidence output by the filter, the confidence range is from 0 to 1, and y is the labeled classification of the sample image, which is generally 0 or 1. The binary cross entropy loss function is used to determine how close the actual output is to the expected output.

For example, in a case that the labeled classification of the positive sample image is 1 and the labeled classification of the negative sample image is 0, when the positive sample image is input, the output of the filter indicates the confidence that the positive sample image belongs to the labeled classification of 1; when the negative sample is input, the output of the filter indicates the confidence that the negative sample image belongs to the labeled classification of 0.

The range of confidence can be from 0 to 1. The network loss can be calculated by inputting the confidence and the labeled classification of the sample image into the loss function.

At step 304, a network parameter of the filter is adjusted according to the network loss.

In specific implementation, the network parameter of the filter can be adjusted through back propagation. When a network iteration ending condition is reached, the network training ends, where the ending condition may be that the iteration reaches a certain number of times, or the network loss is less than a certain threshold.

After the filter is trained, the filter can be connected to the target detection network to filter the detection result of the target detection network.

FIG. 4 is a target detection method provided by an embodiment of the present disclosure. As shown in FIG. 4, the method uses a trained filter as an example to describe the target detection method. The method may include the following steps:

At step 400, a to-be-detected image is received.

In this step, the to-be-detected image can include a plurality of classifications of target objects.

At step 402, a target detection is performed on the to-be-detected image with a target detection network to obtain a detection result.

The detection result includes a target classification to which a target object involved in the to-be-detected image belongs and position information corresponding to the target object involved in the to-be-detected image.

The target detection network can use a well-trained detection network model that is commonly used in target detection.

In this step, the to-be-detected image is input to the target detection network, and the target classification to which each target object belongs and the position information of the target object involved in the to-be-detected image can be output.

At step 404, based on the position information, a proposal image involving the target object is cropped out from the to-be-detected image.

According to the position information output by the target detection network, a proposal image involving the target object involved in the to-be-detected image can be cropped out. When the to-be-detected image includes a plurality of target objects, the plurality of proposal images can be obtained.

At step 406, a confidence that the target object belongs to the target classification is determined with a filter, according to the image feature obtained by performing feature extraction on the proposal image.

In actual implementation, the filter corresponding to the target object of a certain target classification can be pre-trained, and the detected proposal image corresponding to the target object of the target classification is input to the filter for the filter to perform the feature extraction on the proposal image. Thus, the filter can output the confidence that the target object belongs to the target classification according to the image feature.

The image feature can also be obtained by performing the feature extraction on the proposal image in other ways. For example, using a neural network for the feature extraction and inputting the extracted image feature to the filter for the filter to output the confidence that the target object belongs to the target classification.

At step 408, in response to that the confidence is less than a preset threshold, an information item concerned the target object is deleted from the detection result.

If the confidence output by the filter is less than the preset threshold, the target object is determined as another object that has been falsely detected as an object of the target classification, then an information item concerned the target object is deleted from the detection result; if the confidence is greater than or equal to the preset threshold, the target object is determined as an object of the target classification.

In another example, at step 406, a confidence that the target object does not belong to the target classification can be determined. If the confidence is greater than or equal to the preset threshold, the target object is determined as another object that has been falsely detected as an object of the target classification, then an information item concerned the target object is deleted from the detection result; if the confidence is less than the preset threshold, the target object is determined as an object of the target classification.

The confidence may be in a range of 0 to 1. For example, the preset threshold may be set to 0.5, and the specific preset threshold may be set by persons in the art according to actual needs.

At step 410, the proposal image is taken as a negative sample image for training the filter.

For the information item concerned the target object deleted in the previous step, the corresponding proposal image can be used as a negative sample image for training the filter.

In the target detection method provided by the embodiments of the present disclosure, a filter is connected to the target detection network for performing a feature extraction on the proposal image corresponding to the target determined by the target detection, which effectively determines whether the target object belongs to a target classification to be detected according to a confidence, and filters out the target object of which the confidence is less than a preset threshold, thereby reducing false detections and improve detection accuracy without increasing data load. In addition, the proposal image corresponding to the deleted target object is used as a negative sample image for training the filter, which can increase the number of negative sample images and optimize the filter more specifically.

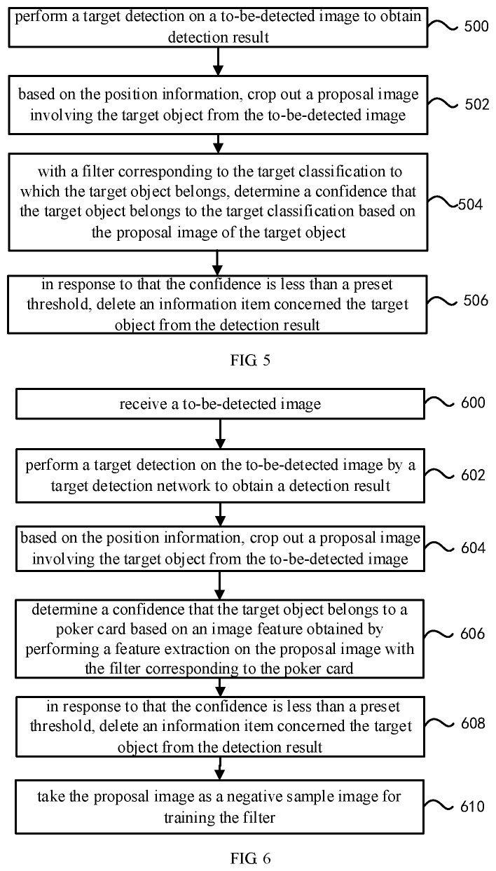

FIG. 5 is another target detection method provided by an embodiment of the present disclosure. In this method, the target objects of a plurality of target classifications can be detected and filtered respectively. The method may include the following steps, wherein the steps that are repeated with the above embodiments will not be repeated.

At step 500, a target detection is performed on a to-be-detected image, and a detection result is obtained.

In a case that one or more target objects are detected from the to-be-detected image, for each of the one or more target objects, the detection result includes: a target classification to which each of at least one target object detected from the to-be-detected image belongs, and position information corresponding to the target object involved in the to-be-detected image. The target classification to which each target object involved in the at least one target object belongs may be the same or different. In this embodiment, a number of the target classifications in the to-be-detected image can be a plurality, where each target classification corresponds to a filter, and the to-be-detected image may also include other objects. In an example, the to-be-detected image may be an image of a game table, and the one or more target objects include at least one of a game prop, a game prop operating part, and a game coin. The other object can be a membership card, tissues, etc.

The to-be-detected image may be input into the target detection network to obtain target objects corresponding to a plurality of classification in the to-be-detected image and the position information of which in the to-be-detected image. However, the other object can be determined as an object of a target classification.

In an example, the classifications of the target objects identified by a pre-detection are A, B, C, and D, respectively, and filters corresponding to the target objects belonging to the classification A, B, C, and D can be pre-trained respectively. In a case that the to-be-detected involves a target object of classification A, a target object of classification D, and other target objects of classification E and F, during the detection, the target object of classification E is falsely detected as a target of classification B, the target object of classification F is falsely detected as a target of classification D. After filtered by filters corresponding to classification B and D respectively, information items concerned the target objects of classification E and F are deleted from the detection result.

At step 502, based on the position information, a proposal image involving the target object is cropped out from the to-be-detected image.

In this step, according to the position information corresponding to each target object, a same number of proposal images as the target objects can be obtained from the to-be-detected image.

At step 504, with a filter corresponding to the target classification to which the target object belongs, a confidence that the target object belongs to the target classification is determined based on the proposal image of the target object.

In this embodiment, the filter corresponding to each target classification can be pre-trained and the training method shown in FIG. 3 can be used to train each filter. The proposal image corresponding to each target object is input into a corresponding filter according to the target classification to which the target object belongs. An image feature is obtained by performing a feature extraction by the filter on the proposal image, and the confidence that the target object belongs to the target classification is output according to the image feature.

The image feature can also be obtained by performing the feature extraction on each proposal image in other ways. For example, using a neural network for the feature extraction and inputting the extracted image feature to a corresponding filter for the filter to output the confidence that the target object belongs to the target classification.

At step 506, in response to that the confidence is less than a preset threshold, an information item concerned the target object is deleted from the detection result.

If the confidence output by the filter is less than the preset threshold, the target object is determined to be another object that has been falsely detected as the target object, and the target object is deleted from the detection result; if the confidence is greater than or equal to the preset threshold, the target object is determined as an object of the target classification.

For the deleted information item concerned the target object, a corresponding proposal image can be used as a negative sample image for training the corresponding filter.

In the target detection method provided by the embodiments of the present disclosure, a filter corresponding to each target classification of target objects is connected on a basis if the target detection. Filters can be used to filter the detection results for the respective target classification of target objects, which can realize the filtering of the detection results of multiple classification of target objects and can improve the efficiency of detection and filtering.

In a specific implementation manner, the target detection method provided by the embodiment of the present disclosure can be applied to a environment of a game venue. In the target detection of the game venue, it is desired to detect game-related target objects (such as poker cards, chips, etc.) with high accuracy, while other objects which collectively referred to as foreign things are not desired to be falsely detected as target objects, thereby affecting the analysis of the system.

However, for the problem of target detection in the game venue, the traditional method is to collect corresponding data of foreign things and increases the number of corresponding negative samples to improve the robustness of the target detection model to foreign things, thereby reducing false detections. However, because the classifications of foreign things cannot be exhausted, and the probability of foreign things appearing in the real scene of the game venue is low, the cost and difficulty of collecting images of a game venue involving foreign things are high, thus difficult to realize.

As shown in FIG. 6, an embodiment of the present disclosure provides a target detection method in a scenario of a game venue. The method may include the following steps, wherein the steps that are repeated with the foregoing embodiment will not be repeated.

At step 600, a to-be-detected image is received.

In this step, the to-be-detected image may be an image of a game table, which may be taken by a camera in the game venue. The image may involve target objects of different target classification, and may also include other objects that are not related to the game. For example, the one or more target object may include at least one of a game prop, a game prop operating part, a game coin, etc., specifically, a poker card, a chip, and a sign.

In this embodiment, poker card detection is taken as an example. The target classification of the target object to be detected and filtered is a poker card. Other objects can be foreign things that are similar in appearance to the poker card, such as a bank card, a membership card, etc., which are easy to be falsely detected by the traditional target detection network as the poker card.

At step 602, a target detection is performed on the to-be-detected image by a target detection network to obtain a detection result.

The detection result includes: a target classification to which each of at least one target object detected from the to-be-detected image belongs, and position information corresponding to the target object involved in the to-be-detected image.

The target detection network can use a trained detection network model that is commonly used for target detection, for example, a Faster RCNN. Data of the game venue can be used to complete the training of the Faster RCNN in advance to perform target detection on conventional objects in the game.

In this step, the to-be-detected image is input into the target detection network, and the target classification to which each target object belongs and the corresponding position information corresponding to the target object involved in the to-be-detected image can be output.

For example, each poker card and corresponding position information, each chip and corresponding position information, and each sign and corresponding position information in the to-be-detected image can be output.

At step 604, based on the position information, a proposal image involving the target object is cropped out from the to-be-detected image.

The proposal image involving the target object involved in the to-be-detected image can be cropped out, that is, the proposal image. When a number of the target objects is a plurality, a respective number of proposal images can be obtained.

In this embodiment, only poker cards can be further detected and filtered. For chips and signs, the target detection result is directly output. In this case, only the filter corresponding to the poker cards is needed. In other embodiments, the chips and signs can also be filtered. For further detection and filtering in this case, filters corresponding to the chips and the signs are needed, which in total are three filters. In particular, a multi-class filter can also be used to filter and detect poker cards, chips and signs at the same time.

In this embodiment, poker card detection is taken as an example, and the proposal image corresponding to each poker card may be cropped out from the to-be-detected image based on the position information corresponding to each poker card. When the position information is frame coordinate information, the proposal image may be an image corresponding to the frame where each poker card is located, and each proposal image may involve a real poker card or a foreign thing that have been falsely detected.

At step 606, a confidence that the target object belongs to a poker card is determined based on an image feature obtained by performing a feature extraction on the proposal image with the filter corresponding to the poker card.

In this embodiment, the filter corresponding to the poker card can be trained in advance. Specifically, a classifier based on deep learning can be used as a filtering model, such as resnet, to complete preliminary training by constructing a binary classification task. The filter is configured to determine whether the input picture is a poker card. The data set required during training includes: positive sample data and negative sample data. The positive sample data is poker card data, which needs to include poker cards face up and reverse face up, and the negative sample data is data on objects similar in appearance to the poker card, such as a membership card, a bank card, a piece of paper, etc. The binary cross entropy loss can be used as the loss function to train the filter.

In this step, the proposal image corresponding to the detected poker card is input into the trained filter, the image feature obtained by performing the feature extraction on the proposal image by the filter, and the confidence that the target object belongs to the poker card is output according to the image feature. The filter predicts a confidence of whether each proposal image involves a poker card.

At step 608, in response to that the confidence is less than a preset threshold, an information item concerned the target object is deleted from the detection result.

The confidence can be in a range of 0 to 1, and the preset threshold can be set to 0.5. When the confidence is less than 0.5, the target object is determined to be a foreign thing that have been falsely detected as a poker card, and the information item concerned the target object is deleted from the objects that are detected as poker cards; if the confidence is greater than or equal to 0.5, it is determined that the target object is indeed an object of poker card.

The target objects that have been falsely detected are removed, and the detection result with higher accuracy is output for subsequent analysis by the system.

At step 610, the proposal image is taken as a negative sample image for training the filter.

For the information item concerned the target object deleted in the previous step, a corresponding proposal image can be used as a negative sample image for training the filter. In particular, a filtered proposal image can also be manually rechecked to further confirm whether it involves a foreign thing. If yes, the proposal image is added to the negative sample data of the filter to continuously optimize filter.

In the target detection method provided by the embodiments of the present disclosure, a filter is connected on the basis of traditional target detection, and a feature extraction is further performed on a proposal image corresponding to a target determined by the target detection, and it is effectively determined whether the target object belongs to a target classification to be detected based on a confidence and the target objects of which the confidence is less than a preset threshold is deleted, so as to filter “foreign things”. It can reduce false detections and improve detection accuracy without increasing the data load and the difficulty of data collection in the game venue. In addition, the proposal image corresponding to the deleted target object is used as negative sample data to train the filter, which can increase the number of negative samples and optimize the filter more targeted. In a smart game venue, it is necessary to determine whether there are foreign things in the game venue. This method can be used to effectively determine whether the target object is a foreign thing, so that the necessary filtering and elimination of foreign things can be made.

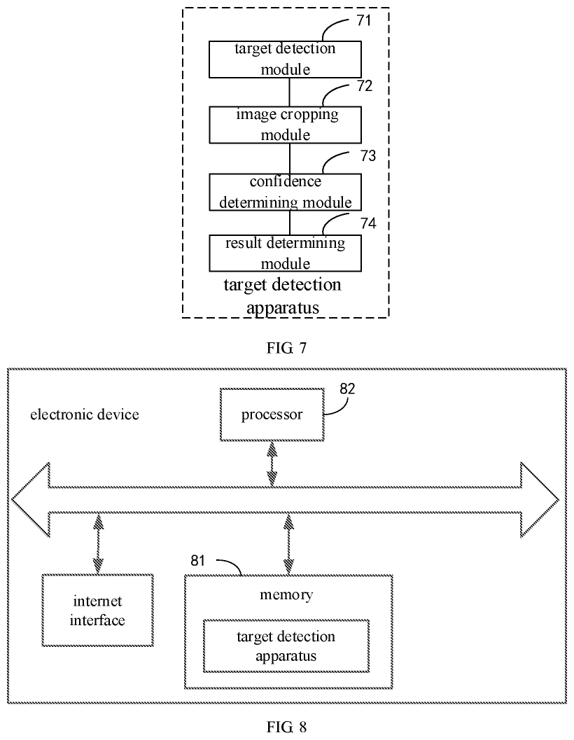

The embodiments of the present disclosure provide a target detection apparatus. As shown in FIG. 7, the apparatus may include: a target detection module 71, an image cropping module 72, a confidence determining module 73, and a result determining module 74.

The target detection module 71 is configured to obtain a detection result by performing a target detection on a to-be-detected image, wherein the detection result includes a target classification to which a target object involved in the to-be-detected image belongs and position information corresponding to the target object involved in the to-be-detected image.

The image cropping module 72 is configured to crop out a proposal image involving the target object from the to-be-detected image based on the position information;

The confidence determining module 73 is configured to determine a confidence that the target object belongs to a target classification based on the proposal image.

The result determining module 74 is configured to in response to that the confidence is less than a preset threshold, delete an information item concerned the target object from the detection result.

On the basis of target detection, by the target detection apparatus provided by the embodiments of the present disclosure, a confidence that the target object belongs to a target classification is determined through a proposal image corresponding to the target object determined by the target detection, and it is effectively determined that whether the target object belongs to the target classification of the target object to be detected based on the confidence. The target object of which the confidence is less than the preset threshold is filtered out, thereby reducing false detections and improving the accuracy of the detection without increasing the data load.

In an example, the target detection module 71 is configured to obtain the detection result by performing the target detection on the to-be-detected image with the target detection network; wherein the target detection network is trained to detect respective target objects of each of a plurality of classifications.

In an example, the confidence determining module 73 is configured to determine a confidence that the target object belongs to the target classification based on an image feature extracted by performing feature extraction on the proposal image with a filter; wherein the filter is trained to detect a target object of the target classification.

In an example, the filter is trained by operations including: extracting an image feature by performing the feature extraction on a sample image with the filter; determining, based on the extracted image feature, a confidence that the sample image belongs to a labeled classification of the sample image, the sample image includes: a positive sample image involving a target object of the target classification and a negative sample image involving an interfering object which does not belong to the target classification; determining a network loss based on the confidence and the labeled classification of the sample image; adjusting a network parameter of the filter based on the network loss.

In an example, the sample image includes at least two classifications of positive sample images, and each of the at least two classifications of positive sample images corresponds to a preset display status of the target object.

In an example, the target object includes a chip-like object which has a marking side and another side opposite to the marking side; the at least two classifications of positive sample images include: an image involving the chip-like object with a first display status in which the marking side of the chip-like object is visible, or an image involving the chip-like object with a second display status in which the marking side of the chip-like object is invisible

In an example, the result determining module 74 is configured to: take, in response to that the confidence is less than the preset threshold, the proposal image as a negative sample image to train the filter.

In an example, in a case that one or more target objects are detected from the to-be-detected image, for each of the one or more target objects, the detection result includes: a target classification to which the target object belongs and position information corresponding to the target object involved in the to-be-detected image; the confidence determining module is configured to: determine, with a filter corresponding to the target classification to which the target object belongs, the confidence that the target object belongs to the target classification based on the proposal image involving the target object.

With reference to any of the embodiments of the present disclosure, the to-be-detected image includes an image of a game table, and the one or more target objects include at least one of a game prop, a game prop operating part, and a game coin.

With reference to any embodiment of the present disclosure, the result determining module 74 is further configured to: store, in response to that the confidence is greater than or equal to the preset threshold, the detection result.

For the implementation process of the functions and roles of each module in the above apparatus, refer to the implementation process of the corresponding steps in the above method for details, which will not be repeated here.

An embodiment of the present disclosure also provides an electronic device. The device includes a memory 81, a processor 82, wherein the memory 81 is configured to store computer-readable instructions that can be run on the processor 82 and when the instructions are executed by the processor 82, the target detection method described in any of the embodiments of the present disclosure is implemented.

An embodiment of the present disclosure also provides a computer program product including computer program(s)/instructions, where when the computer program(s)/instructions are run in a processor, the target detection method described in any of the embodiments of the present disclosure is implemented.

An embodiment of the present disclosure also provides a computer-readable storage medium, having a computer program stored thereon, where when the computer program is executed by a processor, the target detection method described in any of the embodiments of the present disclosure is implemented.

Since the apparatus examples substantially correspond to the method examples, a reference may be made to part of the descriptions of the method examples for the related part. The apparatus examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the disclosure. Those of ordinary skill in the art may understand and carry out them without creative work.

The foregoing describes specific embodiments of this specification. Other embodiments are within the scope of the appended claims. In some cases, the actions or steps described in the claims may be performed in a different order than in the embodiments and still achieve desired results. Moreover, the processes depicted in the figures are not necessarily the particular order or order shown to achieve the desired results. In some implementations, multitasking and parallel processing may be advantageous.

Other implementations of the present disclosure will be apparent to those skilled in the art from consideration of the present disclosure and practice of the present disclosure herein. The present disclosure is intended to cover any variations, uses, modification or adaptations of the present disclosure that follow the general principles thereof and include common knowledge or conventional technical means in the related art that flowchart not herein are intended in the present disclosure. The present disclosure and embodiments are considered as exemplary only, with a true scope and spirit of the present herein are intended being indicated by the following claims.

It is to be understood that the present disclosure is not limited to the precise structure described above and shown in the accompanying drawings, and that various modifications and changes can be made without departing from the scope thereof. The scope of protection of the present disclosure limited only by the appended claims.

The above description is only preferred examples of the present disclosure, and is not intended to limit the present disclosure, and any modifications, equivalents, improvements, etc., which are made within the spirit and principles of the present disclosure, should be included scope of the present disclosure.

1. A target detection method, comprising:
obtaining a detection result by performing a target detection on a to-be-detected image, wherein the detection result comprises a target classification to which a target object involved in the to-be-detected image belongs and position information corresponding to the target object involved in the to-be-detected image;
cropping out a proposal image involving the target object from the to-be-detected image based on the position information;
determining a confidence that the target object belongs to a target classification based on the proposal image; and
deleting, in response to that the confidence is less than a preset threshold, an information item concerned the target object from the detection result.

2. The method of claim 1, wherein obtaining the detection result by performing the target detection on the to-be-detected image comprises:
obtaining the detection result by performing the target detection on the to-be-detected image with a target detection network;
wherein the target detection network is trained to detect respective target objects of each of a plurality of classifications.

3. The method of claim 1, wherein determining the confidence that the target object belongs to the target classification based on the proposal image comprises:
determining the confidence that the target object belongs to the target classification based on an image feature extracted by performing a feature extraction on the proposal image with a filter;
wherein the filter is trained to detect a target object of the target classification.

4. The method of claim 3, wherein the filter is trained by operations comprising:
extracting an image feature by performing the feature extraction on a sample image with the filter;
determining, based on the extracted image feature, a confidence that the sample image belongs to a labeled classification of the sample image, wherein the sample image comprises:
a positive sample image involving a target object of the target classification and
a negative sample image involving an interfering object which does not belong to the target classification;
determining a network loss based on the confidence and the labeled classification of the sample image; and
adjusting a network parameter of the filter based on the network loss.

5. The method of claim 4, wherein
the sample image comprises at least two classifications of positive sample images, and
each of the at least two classifications of positive sample images correspond to a preset display status of the target object.

6. The method of claim 5, wherein
the target object comprises a chip-like object which has a marking side and another side opposite to the marking side;
the at least two classifications of positive sample images comprise:
an image involving the chip-like object with a first display status in which the marking side of the chip-like object is visible, or
an image involving the chip-like object with a second display status in which the marking side of the chip-like object is invisible.

7. The method of claim 3, further comprising:
taking, in response to that the confidence is less than the preset threshold, the proposal image as a negative sample image to train the filter.

8. The method of claim 1, wherein, in a case that one or more target objects are detected from the to-be-detected image, for each of the one or more target objects,
the detection result comprises a target classification to which the target object belongs and position information corresponding to the target object involved in the to-be-detected image; and
determining the confidence that the target object belongs to the target classification based on the proposal image comprises: determining, with a filter corresponding to a target classification to which the target object belongs, the confidence that the target object belongs to the target classification based on the proposal image involving the target object.

9. The method of claim 8, wherein
the to-be-detected image comprises an image of a game table, and
the one or more target objects comprise at least one of a game prop, a game prop operating part, and a game coin.

10. The method of claim 1, further comprising:
storing, in response to that the confidence is greater than or equal to the preset threshold, the detection result.

11. An electronic device, comprising: a memory, a processor, wherein the memory is configured to store computer-readable instructions and the processor is configured to call the instructions to implement a target detection method, the method comprising:
obtaining a detection result by performing a target detection on a to-be-detected image, wherein the detection result comprises a target classification to which a target object involved in the to-be-detected image belongs and position information corresponding to the target object involved in the to-be-detected image;
cropping out a proposal image involving the target object from the to-be-detected image based on the position information;
determining a confidence that the target object belongs to a target classification based on the proposal image; and
deleting, in response to that the confidence is less than a preset threshold, an information item concerned the target object from the detection result.

12. The electronic device of claim 11, wherein obtaining the detection result by performing the target detection on the to-be-detected image comprises:
obtaining the detection result by performing the target detection on the to-be-detected image with a target detection network;
wherein the target detection network is trained to detect respective target objects of each of a plurality of classifications.

13. The electronic device of claim 11, wherein determining the confidence that the target object belongs to the target classification based on the proposal image comprises:
determining the confidence that the target object belongs to the target classification based on an image feature extracted by performing a feature extraction on the proposal image with a filter;
wherein the filter is trained to detect a target object of the target classification.

14. The electronic device of claim 13, wherein the filter is trained by operations comprising:
extracting an image feature by performing the feature extraction on a sample image with the filter;
determining, based on the extracted image feature, a confidence that the sample image belongs to a labeled classification of the sample image, wherein the sample image comprises:
a positive sample image involving a target object of the target classification and
a negative sample image involving an interfering object which does not belong to the target classification;
determining a network loss based on the confidence and the labeled classification of the sample image; and
adjusting a network parameter of the filter based on the network loss.

15. The electronic device of claim 14, wherein
the sample image comprises at least two classifications of positive sample images, and
each of the at least two classifications of positive sample images correspond to a preset display status of the target object.

16. The electronic device of claim 15, wherein
the target object comprises a chip-like object which has a marking side and another side opposite to the marking side;
the at least two classifications of positive sample images comprise:
an image involving the chip-like object with a first display status in which the marking side of the chip-like object is visible, or
an image involving the chip-like object with a second display status in which the marking side of the chip-like object is invisible.

17. The electronic device of claim 13, the method further comprising:
taking, in response to that the confidence is less than the preset threshold, the proposal image as a negative sample image to train the filter.

18. The electronic device of claim 11, wherein, in a case that one or more target objects are detected from the to-be-detected image, for each of the one or more target objects,
the detection result comprises a target classification to which the target object belongs and position information corresponding to the target object involved in the to-be-detected image; and
determining the confidence that the target object belongs to the target classification based on the proposal image comprises: determining, with a filter corresponding to a target classification to which the target object belongs, the confidence that the target object belongs to the target classification based on the proposal image involving the target object.

19. The electronic device of claim 18, wherein
the to-be-detected image comprises an image of a game table, and
the one or more target objects comprise at least one of a game prop, a game prop operating part, and a game coin.

20. A computer readable storage medium, having a computer program stored thereon, wherein in a case that the computer program is executed by a processor, a target detection method is implemented, the method comprising:
obtaining a detection result by performing a target detection on a to-be-detected image, wherein the detection result comprises a target classification to which a target object involved in the to-be-detected image belongs and position information corresponding to the target object involved in the to-be-detected image;
cropping out a proposal image involving the target object from the to-be-detected image based on the position information;
determining a confidence that the target object belongs to a target classification based on the proposal image; and
deleting, in response to that the confidence is less than a preset threshold, an information item concerned the target object from the detection result.
